(19) United States
(12) Patent Application Publication
(10) Pub. No.: US 2026/0282162 A1
(43) Pub. Date: Sep. 17, 2026

(54) RESTRICTION ON COMMUNICATION BASED ON LOCATION OF ORBITING SATELLITE

(71) Applicant: Rakuten Mobile, Inc., Tokyo (JP)

(72) Inventors: Makoto ONO, Tokyo (JP); Bingxuan ZHAO, Tokyo (JP); Ryoji OSAKA, Tokyo (JP); Warangrat WIRIYA, Tokyo (JP); Hyungmin HA, Tokyo (JP)

(21) Appl. No.: 19/235,603

(22) Filed: Jun. 12, 2025

(30) Foreign Application Priority Data
Mar. 13, 2025 (JP) 2025-040701

(51) Int. Cl. H04W 76/36; H04L 43/0876; H04W 64/00; H04W 84/06

(52) U.S. Cl. CPC H04W 76/36; H04L 43/0876; H04W 64/00; H04W 84/06

(57) ABSTRACT

A monitor monitors a load of a cell formed by an orbiting satellite. A communication restrictor restricts communication of some or all of one or more terminals which are communicable with the orbiting satellite within the cell, based on a permissible load at a given time point determined from a location of the orbiting satellite at the given time point and a location of the cell, and on an actual result value or a predicted value of the load of the cell at the given time point.

### CROSS-REFERENCE TO RELATED APPLICATION

This application claims priority to JP 2025-040701, filed on Mar. 13, 2025; the entire contents of which are incorporated herein by reference.

### FIELD

The present disclosure relates to a restriction on communication based on location of orbiting satellite.

### BACKGROUND

In Japanese Patent Application Laid-open No. 2023-000381, there is described a satellite communication system in which each of a plurality of communication satellites communicates by using a frequency hopping method.

The information disclosed in this background section is only for enhancement of understanding of the general background of the disclosure and should not be taken as an acknowledgement or any form of suggestion that this information forms the prior art already known to a person skilled in the art.

### SUMMARY

In wireless communication via an orbiting satellite, it is conceivable that a permissible load, which is a fixed value, is set, and when the load of a cell formed by the orbiting satellite exceeds the permissible load, congestion is prevented from occurring by restricting communication by terminals present in the cell. As used herein, “load” can refer to, for example, a traffic amount, the number of in-cell terminals (total number of terminals in the cell, including unconnected terminals), the number of active terminals (number of terminals communicating in the cell), and the like.

However, in wireless communication via an orbiting satellite, the maximum load at which congestion is prevented from occurring varies depending on the location of the orbiting satellite. For example, when the distance between the orbiting satellite and the cell formed by the orbiting satellite is longer, or when the elevation angle of the orbiting satellite as viewed from the location of the cell is smaller, the maximum load at which congestion is prevented from occurring in the cell becomes smaller.

Thus, when the value of the above-mentioned permissible load is large, congestion may occur in situations in which the distance between the orbiting satellite and the cell is long or the elevation angle of the orbiting satellite as viewed from the location of the cell is small.

Conversely, when the value of the above-mentioned permissible load is small, communication may be overly restricted in situations in which the distance between the orbiting satellite and the cell is short or the elevation angle of the orbiting satellite as viewed from the location of the cell is large.

The present disclosure has been made in view of the above-mentioned circumstances, and has an object to provide a communication control system and a communication control method with which communication via an orbiting satellite can be appropriately restricted in accordance with the location of the orbiting satellite.

A communication control system according to at least one embodiment of the present disclosure executes a monitoring process and a communication restriction process. In the monitoring process, a load of a cell formed by an orbiting satellite is monitored. In the communication restriction process, communication of some or all of one or more terminals which are communicable with the orbiting satellite within the cell is restricted based on a permissible load at a given time point determined from a location of the orbiting satellite at the given time point and a location of the cell, and on an actual result value or a predicted value of the load of the cell at the given time point.

Further, a communication control method according to at least one embodiment of the present disclosure includes monitoring a load of a cell formed by an orbiting satellite. The communication control method also includes restricting communication of some or all of one or more terminals which are communicable with the orbiting satellite within the cell, based on a permissible load at a given time point determined from a location of the orbiting satellite at the given time point and a location of the cell, and on an actual result value or a predicted value of the load of the cell at the given time point.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a diagram for illustrating an example of an implementation environment in at least one embodiment of the present disclosure.

FIG. 2 is a diagram for illustrating an example of a situation in which an orbiting satellite is near the zenith.

FIG. 3 is a diagram for illustrating an example of a situation in which the orbiting satellite is near the horizon.

FIG. 4 is a graph for showing an example of variation in permissible traffic amount over time.

FIG. 5 is a functional block diagram for illustrating an example of functions implemented in a communication control system according to the at least one embodiment of the present disclosure.

FIG. 6 is a table for showing an example of permissible load data.

FIG. 7 is a flowchart for illustrating an example of a flow of processes performed in the communication control system according to the at least one embodiment of the present disclosure.

FIG. 8 is a diagram of example components of a device included in the communication control system.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

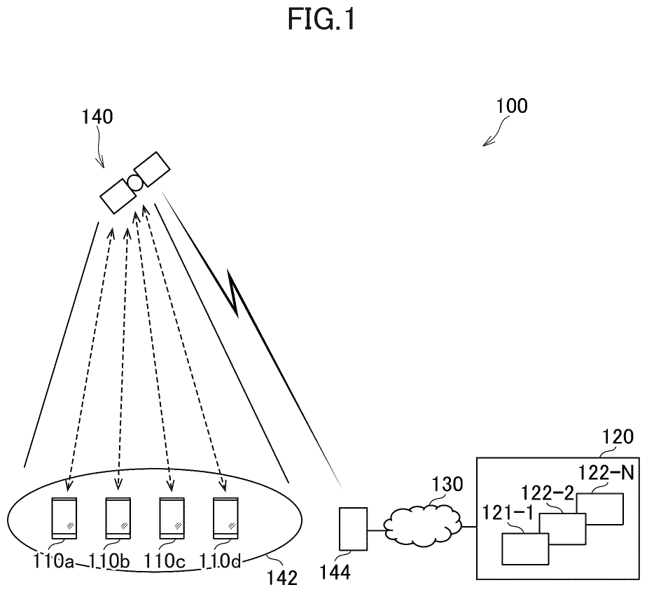

FIG. 1 is a diagram of an example of implementation environment 100 in which systems and/or method, described herein, may be implemented. The implementation environment 100 includes a UE (User equipment) 110, a service environment 120, and a network 130. The service environment 120 include one or more sub-environments 121. To illustrate this, FIG. 1 shows, for convenience, examples of a 1st sub-environment 121-1, a 2nd sub-environment 121-2, and an N-th sub-environment 121-N (where N is any natural number).

The UE 110 is connected to the network 130, and the network 130 is connected to the service environment 120. The connections may be wired, wireless, or a combination of both wired and wireless. The UE 110 and the service environment 120 are connected via the network 130.

The UE 110 is a device that communicates with the service environment 120. The UE 110 receives information from the service environment 120 and/or sends information to the service environment 120. Also, the UE 110 may generate and/or store information to be transmitted, as necessary. Also, the UE 110 may store and/or process information that is received, as necessary.

The example FIG. 1 refers to the “UE”. However, it should be understood by those skilled in the art that general terms such as “user device,” “terminal,” “terminal device,” “communication device,” and “communication terminal” can be used interchangeably with the term “UE.”

For example, the UE 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device.

The service environment 120 is an environment that communicates with the UE 110 to provide one or more services. The service environment 120 receives information from the UE 110 and/or sends information to the UE 110. Also, the service environment 120 may generate and/or store information to be transmitted, as necessary. Also, the service environment 120 may store and/or process information that is received, as necessary. For example, the service environment 120 may provide computing resources as one of the services. It should be noted that the service is not limited to being provided to the UE; it may also be provided to devices other than the UE. For example, based on communication from the UE, the service may perform processes such as anomaly detection or traffic analysis and notify the results to a predetermined destination.

The example FIG. 1 refers to the “service environment”. The term “service environment” is used to refer to the broader context within which services operate. For example, cloud environments, platforms, computing systems, network systems, and cloud systems generally represent the environments in which services are conducted, and these are included within the “service environment.” However, the “service environment” is not limited to these examples. Additionally, the specific types of environments within the “service environment” are not restricted. For instance, cloud environments and cloud systems can be categorized as private cloud, public cloud, hybrid cloud, or multi-cloud, all of which are included within the “service environment.”

The one or more services provided by the service environment 120 is not specifically limited and can be adjusted according to the embodiments. For example, the services may include a service that provides information to the UE 110, a service that stores information from the UE 110, or a service that performs processing based on information from the UE 110 and returns the results of the processing.

In an embodiment, the Service Environments 120 may also provide computing resources as the service. The computing resources can be hardware resources and/or software resources. For example, applications, processors, memory, and storage can be included in the provided computing resources. Each computing resource can communicate with other computing resources via wired connections, wireless connections, or a combination of wired and wireless connections.

The provided computing resources can be actual resources (also referred to as physical resources) and/or virtual resources. Furthermore, means of virtualization for virtual resources can be selected as appropriate. That is, in this disclosure, the use of adjectives such as “Virtual” or “Virtualized” to describe names does not imply that they are virtualized by a specific means of virtualization. For example, “virtual machine” refers to software that operates like an actual computer, realized through means of virtualization, and it is not intended to exclude those realized by specific means of virtualization such as Hypervisors or Containers. Conversely, when means of virtualization such as Hypervisors or containers are mentioned in this disclosure, it is merely cited as a general method of implementation. It should also be interpreted that embodiments implemented with other virtualization means are also disclosed. Also, the services may also be provided using resources virtualized by different means.

The service environment 120 includes one or more devices, such as servers and network devices, which provide services or perform processes. The placement of these devices within the service environment 120 can be determined as appropriate. Additionally, if the service environment 120 includes one or more sub-environments 121, the placement of devices can be determined based on predetermined policies for each sub-environment 121. For example, devices related to the first service may be placed in the 1st sub-environment 121-1, and devices related to the second service may be placed in the 2nd sub-environment 121-2. In another example, devices expected to have a higher load than a predetermined threshold may be placed in the 1st sub-environment 121-1, while devices expected to have a lower load than the predetermined threshold may be placed in the 2nd sub-environment 121-2. In this way, specific devices can be placed in specific sub-environments 121. Conversely, each sub-environment 121 can be specialized for a particular purpose.

In an embodiment, all processes executed in a single service may run within a single service environment, or in multiple service environments. Multiple processes executed in a single service could be provided by different service environments.

The network 130 is a network that exchanges information between the UE 110 and the service environment 120. The network 130 includes one or more wired and/or wireless networks.

For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, a non-terrestrial network (NTN), and/or a combination of these or other types of networks.

The network 130 can be a part of a network. For example, in a 5G network that includes a RAN, a transport network, and a core network, the network 130 can be at least one of the RAN, the transport network, or the core network. For example, the service environment 120 could be in the core network, in which case the network 130 could correspond to a network that is a combination of a RAN and a transport network and is part of the 5G network.

The number and arrangement of devices and networks shown in FIG. 1 are provided as an example. It should be understood that any changes that may be implemented by those skilled in the art, such as the addition or rearrangement of well-known devices or networks at the time of implementation, are included in this disclosure.

The implementation environment 100 illustrated in FIG. 1 is now further described.

In at least one embodiment of the present disclosure, a UE 110 within a range of a cell 142, which is the communication range of an orbiting satellite 140, communicates with the service environment 120 via the orbiting satellite 140, a ground gateway device 144, and the network 130. In FIG. 1, a case in which there are four UEs 110, namely, a UE 110a to a UE 110d, is illustrated as an example.

When a UE 110 is within the range of both of a cell formed by a ground antenna and the cell 142 formed by the orbiting satellite 140, communication via the ground antenna may be given priority.

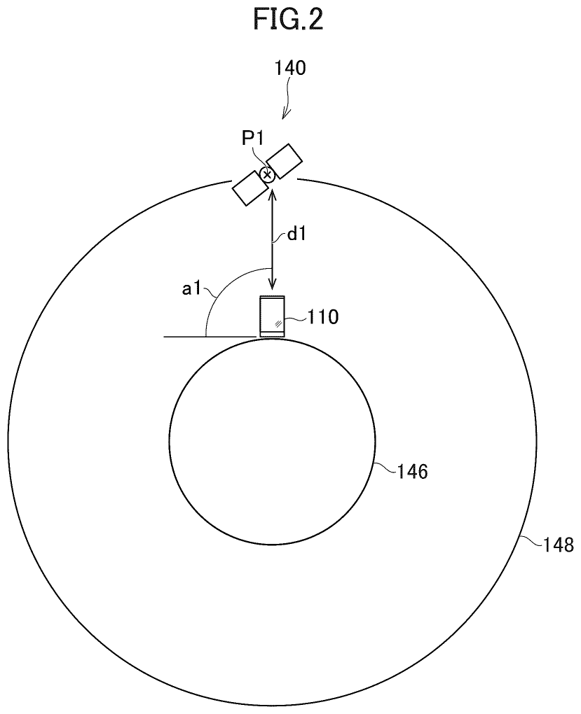

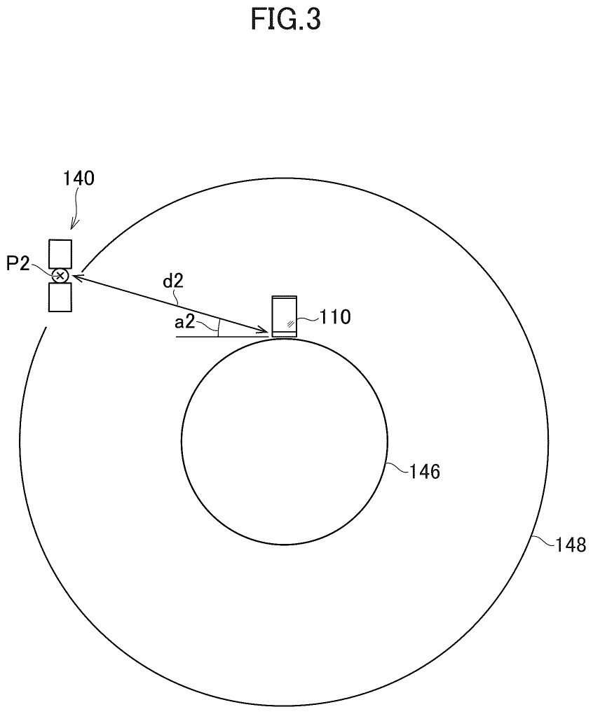

FIG. 2 is a diagram for illustrating an example of a situation in which the orbiting satellite 140, which is on an orbit 148 around the Earth 146, is at a location P1 near the zenith. FIG. 3 is a diagram for illustrating an example of a situation in which the orbiting satellite 140, which is on the orbit 148 around the Earth 146, is at a location P2 near the horizon.

In the at least one embodiment, for example, the orbiting satellite 140 orbits the Earth 146 in a predetermined time (for example, approximately 1 hour and 40 minutes). Further, the orbiting satellite 140, which has an elevation angle as viewed from the location of the cell 142 within a predetermined range (for example, 20 degrees or more), communicates with the UEs 110 present in the cell 142. In the following description, the part of the orbit 148 having an elevation angle as viewed from the location of the cell 142 within the predetermined range (for example, 20 degrees or more) is referred to as “coverage range.”

For example, at least one orbiting satellite 140 within the predetermined range among a plurality of orbiting satellites 140 may form the cell 142. For example, a plurality of orbiting satellites 140 may be on the orbit 148, and those plurality of orbiting satellites 140 may handle communication between the UEs 110 in the cell 142 and the service environment 120 while handing off to and from each other. Further, one orbiting satellite 140 or a plurality of orbiting satellites 140 may handle communication between the UEs 110 in the cell 142 and the service environment 120. For example, at a given one point in time, one orbiting satellite 140 may handle communication between the UEs 110 in the cell 142 and the service environment 120, and at another given point in time, a plurality of orbiting satellites 140 may handle communication between the UEs 110 in the cell 142 and the service environment 120.

Further, in the at least one embodiment, the location of the cell 142 may be fixed regardless of the location of the orbiting satellite 140. In addition, the orbiting satellite 140 may be a low-earth orbiting satellite.

A distance d1 between the orbiting satellite 140 and the UE 110 in the situation illustrated in FIG. 2 is shorter than a distance d2 between the orbiting satellite 140 and the UE 110 in the situation illustrated in FIG. 3. Further, an elevation angle a1 of the orbiting satellite 140 as viewed from the location of the UE 110 in the situation illustrated in FIG. 2 is larger than an elevation angle a2 of the orbiting satellite 140 as viewed from the location of the UE 110 in the situation illustrated in FIG. 3. Thus, the maximum load at which congestion is prevented from occurring in communication performed by the UE 110 present in the cell 142 is smaller in the situation illustrated in FIG. 3 than in the situation illustrated in FIG. 2. Here, the load is, for example, the traffic amount, the number of in-cell terminals (total number of terminals in the cell, including unconnected terminals), the number of active terminals (number of terminals communicating in the cell), or the like.

For example, it is conceivable that a permissible load, which is a fixed value, is set, and when the load of the cell 142 formed by the orbiting satellite 140 exceeds the permissible load, congestion is prevented from occurring by restricting communication by the UEs 110 present in the cell 142.

However, in wireless communication via the orbiting satellite 140, as described above, the maximum load at which congestion is prevented from occurring varies depending on the location of the orbiting satellite 140.

Thus, when the set value of the permissible load described above is large, congestion may occur in situations as illustrated in FIG. 3 in which the distance between the orbiting satellite 140 and the UE 110 is long or the elevation angle of the orbiting satellite 140 as viewed from the location of the cell 142 is small.

Conversely, when the set value of the permissible load is small, communication may be overly restricted in situations as illustrated in FIG. 2 in which the distance between the orbiting satellite 140 and the cell 142 is short or the elevation angle of the orbiting satellite 140 as viewed from the location of the cell 142 is large.

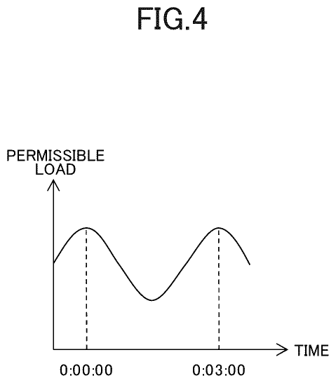

Taking the above into consideration, in the at least one embodiment, as shown in FIG. 4, the permissible load is caused to vary over time. In addition, based on the time-variable permissible load and an actual result value or a predicted value of the load of the cell 142, the communication of some or all of the one or more UEs 110 that can communicate with the orbiting satellite 140 within the cell 142 is restricted.

Thus, in the at least one embodiment, communication via the orbiting satellite 140 can be appropriately restricted in accordance with the location of the orbiting satellite 140.

In the event of, for example, a disaster, the demand for access to the orbiting satellite 140 may suddenly increase. In addition, the demand for access to the orbiting satellite 140 may also suddenly increase in cases such as when a base station device which relays communication via a ground antenna goes down. In the at least one embodiment, even when such a situation occurs, it is possible to appropriately restrict communication via the orbiting satellite 140.

As shown in FIG. 4, the permissible load in the at least one embodiment may vary periodically (for example, over a three-minute cycle) over time. The length of the cycle may be the same as the length of the period from when a certain orbiting satellite 140 enters the above-mentioned coverage range to when the certain orbiting satellite 140 leaves the coverage range, for example. FIG. 4 is merely a graph which schematically shows one example of the variation in the permissible load over time.

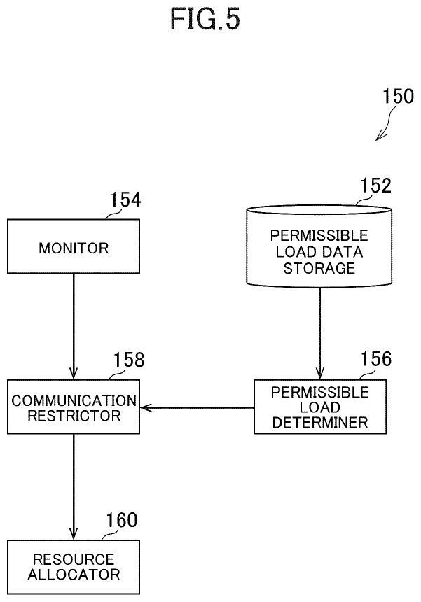

FIG. 5 is a functional block diagram for illustrating an example of functions implemented in a communication control system 150 according to the at least one embodiment of the present disclosure. The communication control system 150 according to the at least one embodiment is not required to implement all the functions illustrated in FIG. 5, and may implement functions other than those illustrated in FIG. 5.

As illustrated in FIG. 5, the communication control system 150 according to the at least one embodiment includes, in terms of functions, for example, a permissible load data storage 152, a monitor 154, a permissible load determiner 156, a communication restrictor 158, and a resource allocator 160.

The functions illustrated in FIG. 5 may be implemented by executing, by the processor included in the communication control system 150, a program that is installed in the communication control system 150 and that includes instructions corresponding to the functions. The program may be supplied to the communication control system 150 via a computer-readable information storage medium, such as an optical disc, a magnetic disk, a magnetic tape, a magneto-optical disc, a flash memory, or the like, or via the Internet or the like. The functions illustrated in FIG. 5 may also be implemented by a circuit block, a memory, and other LSIs. Further, a person skilled in the art would understand that the functions illustrated in FIG. 5 can be implemented in various forms by only hardware, by only software, or by a combination of hardware and software.

The communication control system 150 may be implemented, for example, by an operation support system (OSS) included in the service environment 120. The communication control system 150 may also be implemented, for example, by one or more sub-environments 121.

Some or all of the functions illustrated in FIG. 5 may be implemented by a base station device. The base station device may be included in the network 130. Further, the base station device may be included in the service environment 120. Further, the base station device may be included in the orbiting satellite 140. Further, the base station device may be included in the gateway device 144.

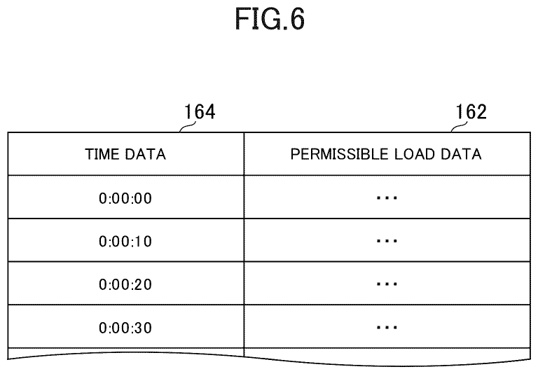

In the at least one embodiment, for example, the permissible load data storage 152 stores permissible load data 162, an example of which is shown in FIG. 6. The permissible load data storage 152 may store a plurality of pieces of permissible load data 162 each associated with a different time point. In FIG. 6, a case in which there are four pieces of the permissible load data 162 is shown as an example.

As shown in FIG. 6, the permissible load data 162 in the at least one embodiment may be associated with time data 164. For example, as the value of a given piece of the permissible load data 162, a value indicating the permissible load at the time indicated by the time data 164 associated with that piece of permissible load data 162 may be set. The permissible load as used herein may indicate at least one of a permissible traffic amount, a permissible number of in-cell terminals (hereinafter also referred to as “permissible number of in-cell UEs”), or a permissible number of active terminals (hereinafter also referred to as “permissible number of active UEs”). For example, the permissible load may be at least one of the permissible traffic amount, the permissible number of in-cell UEs, or the number of permissible active UEs. Further, the permissible load may be a weighted sum of at least two of the permissible traffic amount, the permissible number of in-cell UEs, or the number of permissible active UEs. Further, as shown in FIG. 6, the time indicated by the time data 164 may be a predetermined time interval (a 10-second interval in the example of FIG. 6).

In addition, as described with reference to FIG. 4, the value of the permissible load data 162 may be set to a value that varies periodically over time, with one cycle being a predetermined time (for example, three minutes). In the at least one embodiment, for example, the one cycle is set to be longer than the time interval indicated by time data 164.

For example, an expression for calculating the permissible load may be determined in advance based on the location of orbiting satellite 140 and the location of the cell 142. The permissible load at a given time point may be calculated in accordance with the expression based on the location of the orbiting satellite 140 at that time point and the location of the cell 142.

The parameters of the expression may include at least one of the distance between the orbiting satellite 140 and the cell 142 or the elevation angle of the orbiting satellite 140 as viewed from the location of the cell 142. The parameters of the expression may be calculated based on the location of the orbiting satellite 140 at a given time point and the location of the cell 142. The permissible load at that time point may be calculated based on the calculated parameters and the expression. Thus, the permissible load may be determined based on at least one of the distance between the orbiting satellite 140 and the cell 142 or the elevation angle of the orbiting satellite 140 as viewed from the location of the cell 142.

The parameters of the expression may also include an atmospheric condition (for example, electron density in the ionosphere, presence or absence of a geomagnetic storm, or weather). Further, the permissible load at a given time point may be calculated based on the results of a prediction of the atmospheric condition at that time point calculated by using an existing method.

As another example, the values of the permissible load data 162 associated with each of a plurality of time points may be determined based on the value of a parameter indicating a communication quality, such as a radio wave strength, of the UEs 110 present in the cell 142 at a plurality of time points measured in the past. Even in this way, the value of the permissible load data 162 associated with a given time point is considered to be determined based on the location of the orbiting satellite 140 at that time point and the location of the cell 142.

Further, the above-mentioned expression may be determined based on an empirical rule such as past measurement values or experimental results, and the values of the permissible load data 162 associated with each of the plurality of time points may be determined based on the determined expression.

The above-mentioned method of determining the value of the permissible load data 162 is merely one example, and the value of the permissible load data 162 at each of the plurality of time points may be determined by using an appropriate optimal method.

In the at least one embodiment, for example, the monitor 154 monitors the load of the cell 142 formed by the orbiting satellite 140. The load of the cell 142 as used herein may indicate at least one of a traffic amount of the cell 142, the number of in-cell terminals of the cell 142 (hereinafter also referred to as “number of in-cell UEs”), or the number of active terminals of the cell 142 (hereinafter also referred to as “number of active UEs”). For example, the monitor 154 may monitor at least one of the traffic amount of the cell 142, the number of in-cell UEs of the cell 142, or the number of active UEs of the cell 142. Further, the monitor 154 may monitor an index represented by a weighted sum of at least two of the traffic amount of the cell 142, the number of in-cell UEs of the cell 142, or the number of active UEs of the cell 142. In the following description, the number of in-cell UEs refers to the number of UEs 110 in the cell 142, and refers to the sum of the number of UEs 110 that are currently performing communication and the number of UEs 110 that are not connected. In addition, the number of active UEs refers to the number of UEs 110 in the cell 142 that are currently performing communication.

The load monitored by the monitor 154 and the permissible load indicated by the permissible load data 162 may be the same or different. The monitor 154 may also identify the load of the cell 142 at predetermined time intervals (for example, 10-second intervals).

In the at least one embodiment, for example, the permissible load determiner 156 determines the permissible load based on the permissible load data 162 described above.

In the at least one embodiment, the communication restrictor 158 restricts communication of some or all of the one or more UEs 110 that can communicate with the orbiting satellite 140 within the cell 142, based on, for example, the permissible load at a given time point determined from the location of the orbiting satellite 140 at that given time point and the location of the cell 142, and on an actual result value or a predicted value of the load of the cell 142 at that given time point.

In the at least one embodiment, for example, the resource allocator 160 allocates resources to the UEs 110 that are permitted to communicate with the orbiting satellite 140. The resource allocator 160 may allocate, to each UE 110 that is permitted to communicate with the orbiting satellite 140, an amount of resources corresponding to the communication usage of the UE 110.

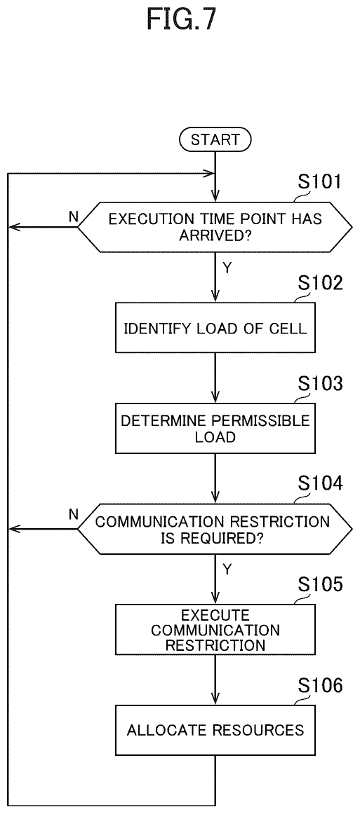

Description is now given of an example of a flow of processes performed by the communication control system 150 according to the at least one embodiment with reference to a flowchart illustrated in FIG. 7. In the present process example, it is assumed that execution time points which arrive at predetermined time intervals (for example, 10-second intervals) have been determined in advance. In the at least one embodiment, for example, the intervals between the execution time points are set to be shorter than the length of the period from when a certain orbiting satellite 140 enters the above-mentioned coverage range until the certain orbiting satellite 140 leaves the coverage range. Further, the intervals between the execution time points may be the same as the intervals between the times indicated by the time data 164.

First, the monitor 154 monitors whether or not an execution time point has arrived (Step S101).

When an execution time point has arrived, the monitor 154 identifies the load of the cell 142 (Step S102).

Then, the permissible load determiner 156 determines the permissible load (Step S103).

Then, the communication restrictor 158 determines whether or not communication restriction is required based on the load identified in the process step of Step S102 and the permissible load determined in the process step of Step S103 (Step S104).

When it is determined in the process step of Step S104 that communication restriction is not required (Step S104: N), the process returns to the process step of Step S101. Meanwhile, when it is determined in the process step of Step S104 that communication restriction is required (Step S104: Y), the communication restrictor 158 executes communication restriction (Step S105).

When the process step of Step S105 ends, the resource allocator 160 allocates, to each of the UEs 110 that are permitted to communicate with the orbiting satellite 140, an amount of resources corresponding to the communication usage of the UE 110 (Step S106), and the process returns to the process step of Step S101.

In the process step of Step S102, the monitor 154 may identify an actual result value of the load of the cell 142 at the execution time point that has arrived. Then, in the process step of Step S103, the permissible load determiner 156 may determine, as the permissible load, the load indicated by the permissible load data 162 associated with the time data 164 indicating the time of the execution time point that has arrived.

As another example, in the process step of Step S102, the monitor 154 may identify an actual result value of the load of the cell 142 at a future prediction time point (for example, 5 minutes after the execution time point that has arrived) by extrapolating the actual result value of the load of the cell 142 at one or more execution time points on or before the execution time point that has arrived. Then, in the process step of Step S103, the permissible load determiner 156 may determine, as the permissible load, the load indicated by the permissible load data 162 associated with the time data 164 indicating the time of the prediction time point.

Further, in the process step of Step S102, the monitor 154 may identify, as the load of the cell 142, an index value calculated based on a plurality of metrics to be monitored.

Then, in the process step of Step S104, when the permissible load determined in the process step of Step S103 is smaller than the load of the cell 142 identified in the process step of Step S102, the communication restrictor 158 may determine that communication restriction is required. Meanwhile, when the permissible load determined in the process step of Step S103 is equal to or more than the load of the cell 142 identified in the process step of Step S102, the communication restrictor 158 may determine that communication restriction is not required.

There is no particular limitation on the method of communication restriction executed in the process step of Step S105.

For example, there may be a case in which the permissible load data 162 indicates a permissible traffic amount, the number of in-cell UEs Na at the prediction time point has been identified in the process step of Step S102, and the permissible traffic amount at the prediction time point has been determined in the process step of Step S103.

In this case, in the process step of Step S104, the communication restrictor 158 may determine the number of accommodatable terminals Nc by multiplying the predicted value of the permissible traffic amount determined in the process step of Step S103 by a predetermined coefficient. Further, the communication restrictor 158 may determine the number of UEs requesting communication Nd by multiplying the number of in-cell UEs Na identified in the process step of Step S102 by a predetermined coefficient. Then, the communication restrictor 158 may determine that communication restriction is required when the number of UEs requesting communication Nd is larger than the number of accommodatable terminals Nc.

Then, when it is determined that communication restriction is required, in the process step of Step S105, the communication restrictor 158 may calculate a restriction ratio Rbar in accordance with the following expression: (predetermined coefficient C)×((number of UEs requesting communication Nd)−(number of accommodatable terminals Nc))/(number of in-cell UEs Na).

Then, the communication restrictor 158 may transmit a restriction instruction to the UEs 110 for which communication is restricted via the orbiting satellite 140 forming the cell 142 among the plurality of orbiting satellites 140. Here, for example, access class barring (ACB) may be used to restrict outgoing transmission from the UEs 110. For example, the communication restrictor 158 may output, to the base station device, access classes restricting outgoing transmission. Then, the base station device may transmit a system information block (SIB) indicating one or more access classes which restrict outgoing transmission to the UEs 110 via the orbiting satellite 140. When the access class of a UE 110 that has received the SIB is included in the access classes indicated in the SIB as an access class that restricts outgoing transmission, the UE 110 may suppress the outgoing transmission of radio waves.

For example, when the calculated restriction ratio Rbar is 0.3, the communication restrictor 158 may randomly determine three access classes from among access classes of 0 to 9. Then, the communication restrictor 158 may output the determined three access classes to the base station device. Then, the base station device may transmit an SIB indicating those three access classes to the UEs 110 via the orbiting satellite 140. When the access class of a UE 110 that has received the SIB is any one of the determined three access classes, the UE 110 may suppress the outgoing transmission of radio waves.

In addition, probabilistic access restriction (probabilistic barring) may be used to restrict outgoing transmission from some or all of one or more the UEs 110 that can communicate with the orbiting satellite 140 within the cell 142. In this case, a restriction probability (barring factor) may be included in the above-mentioned SIB. Then, a UE 110 that has received the SIB may determine, in accordance with the restriction probability included in the SIB, whether or not radio waves may be output. When the UE 110 determines that radio waves are not to be output, the UE 110 may suppress the outgoing transmission of radio waves. For example, when the calculated restriction ratio Rbar is 0.3, a restriction probability having a value of 0.3 may be included in the SIB.

The above-mentioned SIB may include both a designation of the access classes restricting outgoing transmission and the restriction probability.

In the manner described above, the communication restrictor 158 may restrict outgoing transmission from some or all of the one or more UEs 110 that can communicate with the orbiting satellite 140 within the cell 142.

Regarding the process step of Step S106, in the at least one embodiment, a UE 110 present in the cell 142 may be connected to a network slice corresponding to the usage of the UE 110. Then, in the process step of Step S106, the resource allocator 160 may determine, for each of a plurality of network slices, a ratio of the load to be allocated to that network slice in accordance with a given rule. Further, the resource allocator 160 may allocate, to each of the plurality of network slices, an amount of resources equivalent to a load obtained by multiplying the permissible load by the ratio determined for that network slice.

In addition, in the process step of Step S106, when there is a network slice which has available resources, the resource allocator 160 may allocate the resources of that network slice to a UE 110 connected to another network slice.

As described with reference to FIG. 7, the communication restrictor 158 may repeatedly execute a determination as to whether or not to restrict communication of some or all of the one or more UEs 110 that can communicate with the orbiting satellite 140 within the cell 142 based on a most recent monitoring result of the load of the cell 142.

As described above, the method of communication restriction performed by the communication restrictor 158 is not limited to the method described above.

For example, the communication restrictor 158 may disconnect communication of some or all of the one or more UEs 110 that can communicate with the orbiting satellite 140 within the cell 142. For example, when the permissible load determined in the process step of Step S103 is 80% of the load of the cell 142 identified in the process step of Step S102, in this case, the communication restrictor 158 may determine a disconnection rate to be 30% by multiplying 20%, which is obtained by subtracting 80% from 100%, by a predetermined coefficient (here, for example, 1.5). Then, the communication restrictor 158 may output to the base station device an instruction to disconnect communication of 30% of the UEs 110 that are currently performing communication. Then, in accordance with the disconnection instruction, the base station device may disconnect communication of, for example, randomly selected UEs 110 (for example, 30% of the UEs 110 that are currently performing communication).

Further, the communication restrictor 158 may restrict a communication speed of some or all of the one or more UEs 110 that can communicate with the orbiting satellite 140 within the cell 142. For example, as described above, when the permissible load determined in the process step of Step S103 is 80% of the load of the cell 142 identified in the process step of Step S102, in this case, the communication restrictor 158 may determine a communication speed restriction rate to be 30% by multiplying 20%, which is obtained by subtracting 80% from 100%, by a predetermined coefficient (here, for example, 1.5). Then, the communication restrictor 158 may instruct the base station device to set the upper limit of the communication speed to be 70% of the current communication speed upper limit. Then, in accordance with the instruction, the base station device may set the upper limit of the communication speed of the UEs 110 that are currently performing communication to 70% of the current communication speed upper limit.

Further, the communication restrictor 158 may restrict the number of terminals which are permitted to communicate with the orbiting satellite 140 within the cell 142. For example, as described above, when the permissible load determined in the process step of Step S103 is 80% of the load of the cell 142 identified in the process step of Step S102, in this case, the communication restrictor 158 may determine a terminal restriction rate to be 30% by multiplying 20%, which is obtained by subtracting 80% from 100%, by a predetermined coefficient (here, for example, 1.5). The communication restrictor 158 may output 70% of the current number of in-cell UEs (or, number of active UEs) to the base station device as the number of terminals permitted to communicate. Then, the base station device may disconnect communication of randomly selected UEs 110, for example, so that the number of terminals currently performing communication becomes 70% of the current number of in-cell UEs (or, number of active UEs). As another example, the base station device may reject authentication in response to requests from a certain number of UEs 110.

Further, when it is determined in the process step of Step S104 that communication restriction is required, then in the process step of Step S105, the communication restrictor 158 may restrict communication of a predetermined ratio (for example, 10%) of the UEs 110.

For example, when it is determined that communication restriction is required at a certain execution time point, the communication restrictor 158 may restrict outgoing transmission from UEs 110 having an access class of 0. At the next execution time point, when it is again determined that communication restriction is required, the communication restrictor 158 may restrict outgoing transmission from the UEs 110 having an access class of 1. Thereafter, outgoing transmission from the UEs 110 having an access class of 2, the UEs 110 having an access class of 3, and so on may be restricted.

Further, for example, in a situation in which outgoing transmission from the UEs 110 having an access class of 0 to 3 is restricted, when it is determined that communication restriction is not required, the communication restrictor 158 may end the restriction on outgoing transmission from the UEs 110 having an access class 0.

Further, in the at least one embodiment, permissible traffic amount data is not required to be stored in advance in the permissible load data storage 152. For example, expression data indicating an expression for calculating the permissible load may be stored in the permissible load data storage 152. In the process step of Step S103, the permissible load determiner 156 may calculate the permissible load at the current time point based on the location of the orbiting satellite 140 at the current time point, the location of the cell 142, and the expression indicated by the expression data. The expression may be based on an empirical rule such as past measurement values or experimental results.

Further, in a situation in which communication by the UEs 110 present in the cell 142 is restricted, the communication restrictor 158 may restrict communication of some or all of the one or more UE 110 that can communicate with the orbiting satellite 140 within the cell 142 based on the situation of restriction of the communication.

For example, as described above, in a case in which communication restriction based on a restriction ratio Rbar calculated in accordance with the expression: (predetermined coefficient C)×((number of UEs requesting communication Nd)−(number of accommodatable terminals Nc))/(number of in-cell UEs Na) has been executed at the immediately preceding execution time point, in this case, the communication restrictor 158 may determine that communication restriction is required when the value obtained by dividing the number of UEs requesting communication Nd by the restriction ratio Rbar which is being applied is more than the number of accommodatable terminals Nc. Further, when it is determined that communication restriction is required, the communication restrictor 158 may calculate the restriction ratio Rbar for the most recent execution time point in accordance with the expression: (predetermined coefficient C)×(((number of UEs requesting communication Nd)/(restriction ratio Rbar being applied))−(number of accommodatable terminals Nc))/(number of in-cell UEs Na).

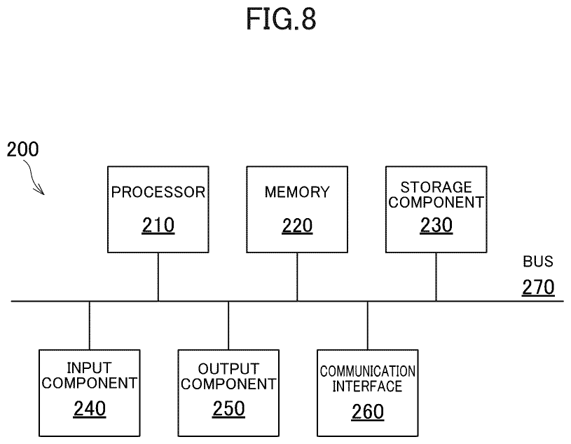

FIG. 8 illustrates an embodiment of a device 200 included in the communication control system. As shown in FIG. 8, the device 200 includes processor 210, a memory 220, a storage component 230, an input component 240, an output component 250, a communication interface 260, and a bus 270.

The processor 210, as used herein, means any type of computational circuit that may comprise hardware elements and software elements. The processor 210 may be embodied as a multi-core processor, a single core processor, or a combination of one or more multi-core processors and/or one or more single core processors, a distributed processing system, or the like. The processor 210 may be a Central Processing Unit (CPU), a graphics processing unit (GPU), an accelerated processing unit (APU), an application-specific integrated circuit (ASIC), or another type of processing component.

Memory 220 includes a non-transitory computer readable medium. Memory 220 includes a random-access memory (RAM), a read only memory (ROM), and/or another type of dynamic or static storage device (e.g., a flash memory, a magnetic memory, and/or an optical memory) that stores information and/or instructions for use by processor 210. The memory 220 comprises machine-readable instructions which are executable by the processor 210. These machine-readable instructions when executed by the processor 210 cause the processor 210 to perform one or more method steps of an embodiment described above.

Storage component 230 stores information and/or software related to the operation and use of the device 200. For example, storage component 230 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 240 is configured to receive information, such as user input. For example, the input component 240 may include, but not be limited to, a touch screen display, a keyboard, a keypad, a mouse, a button, a switch, and/or a microphone. Additionally, or alternatively, the input component 240 may include a sensor for sensing information (e.g., a global positioning system (GPS), an accelerometer, a gyroscope, and/or an actuator).

Output component 250 is configured to provide output information from the device 200. For example, the output component 250 may be, but not limited to, a display, a speaker, an instruction device to an external device, and/or one or more light-emitting diodes (LEDs).

Communication interface 260 is an interface that provides a communication connection to other devices, such as external devices and internal devices. The connection by the communication interface 260 can be a wired connection, a wireless connection, or a combination of wired and wireless connections, and can be a direct connection or an indirect connection via a communication network that exists between the device 200 and other devices. In other words, the standard of the communication interface 260 is not limited.

The bus 270 acts as an interconnect between the processor 210, the memory 220, the storage component 230, the input component 240, the output component 250, and the communication interface 260 of the device 200. The bus 270 may include a wired interconnection or a wireless interconnection.

The number and arrangement of components shown in FIG. 8 are provided as an example. In practice, device 200 may include additional components, fewer components, different components, or differently arranged components than those shown in FIG. 8. Additionally, or alternatively, a set of components (e.g., one or more components) of device 200 may perform one or more functions described as being performed by another set of components of device 200. Further, one or more method steps described in any of the embodiments may be performed utilizing a plurality of devices 200 in communication with one another.

The technology disclosed in the present disclosure can also be expressed as follows.

[1] A communication control system, including:
monitoring means for monitoring a load of a cell formed by an orbiting satellite; and
communication restriction means for restricting communication of some or all of one or more terminals which are communicable with the orbiting satellite within the cell, based on a permissible load at a given time point determined from a location of the orbiting satellite at the given time point and a location of the cell, and on an actual result value or a predicted value of the load of the cell at the given time point.

[2] The communication control system according to Item [1], wherein the communication restriction means is configured to restrict outgoing transmission from the some or all of the one or more terminals which are communicable with the orbiting satellite within the cell.

[3] The communication control system according to Item [1], wherein the communication restriction means is configured to disconnect the communication of the some or all of the one or more terminals which are communicable with the orbiting satellite within the cell.

[4] The communication control system according to Item [1], wherein the communication restriction means is configured to restrict a communication speed of the some or all of the one or more terminals which are communicable with the orbiting satellite within the cell.

[5] The communication control system according to Item [1], wherein the communication restriction means is configured to the number of terminals permitted to communicate with the orbiting satellite within the cell.

[6] The communication control system according to any one of Items [1] to [5], wherein the permissible load is determined based on at least one of a distance between the orbiting satellite and the cell or an elevation angle of the orbiting satellite as viewed from the location of the cell.

[7] The communication control system according to any one of Items [1] to [6], wherein the communication restriction means is configured to repeatedly execute a determination as to whether to restrict the communication of the some or all of the one or more terminals which are communicable with the orbiting satellite within the cell based on a most recent monitoring result of the load of the cell.

[8] The communication control system according to any one of Items [1] to [7],
wherein the cell is formed by at least one orbiting satellite which is within a predetermined range among a plurality of orbiting satellites, and
wherein the communication restriction means is configured to transmit a restriction instruction to the some or all of the one or more terminals for which the communication is restricted via the at least one orbiting satellite forming the cell among the plurality of orbiting satellites.

[9] The communication control system according to any one of Items [1] to [8], wherein the permissible load varies periodically over time.

[10] The communication control system according to any one of Items [1] to [9], further including resource allocation means for allocating, to a terminal which is permitted to communicate with the orbiting satellite, an amount of resources corresponding to a communication usage of the terminal.

[11] The communication control system according to any one of Items [1] to [10], wherein the communication restriction means is configured to restrict, in a situation in which communication by terminals present in the cell is restricted, the communication of the some or all of the one or more terminals which are communicable with the orbiting satellite within the cell based on the situation of restriction of the communication.

[12] The communication control system according to any one of Items [1] to [11], wherein the location of the cell is fixed regardless of the location of the orbiting satellite.

[13] The communication control system according to any one of Items [1] to [12], wherein the orbiting satellite is a low-earth orbiting satellite.

[14] The communication control system according to any one of Items [1] to [13], wherein the permissible load indicates at least one of a permissible traffic amount, a permissible number of in-cell terminals, or a permissible number of active terminals.

[15] The communication control system according to any one of Items [1] to [14], wherein the load of the cell indicates at least one of a traffic amount of the cell, the number of in-cell terminals of the cell, or the number of active terminals of the cell.

[16] A communication control method, comprising:
monitoring a load of a cell formed by an orbiting satellite; and
restricting communication of some or all of one or more terminals which are communicable with the orbiting satellite within the cell, based on a permissible load at a given time point determined from a location of the orbiting satellite at the given time point and a location of the cell, and on an actual result value or a predicted value of the load of the cell at the given time point.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A communication control system which executes:
a monitoring process of monitoring a load of a cell formed by an orbiting satellite; and
a communication restriction process of restricting communication of some or all of one or more terminals which are communicable with the orbiting satellite within the cell, based on a permissible load at a given time point determined from a location of the orbiting satellite at the given time point and a location of the cell, and on an actual result value or a predicted value of the load of the cell at the given time point.

2. The communication control system according to claim 1, wherein the communication restriction process includes restricting outgoing transmission from the some or all of the one or more terminals which are communicable with the orbiting satellite within the cell.

3. The communication control system according to claim 1, wherein the communication restriction process includes disconnecting the communication of the some or all of the one or more terminals which are communicable with the orbiting satellite within the cell.

4. The communication control system according to claim 1, wherein the communication restriction process includes restricting a communication speed of the some or all of the one or more terminals which are communicable with the orbiting satellite within the cell.

5. The communication control system according to claim 1, wherein the communication restriction process includes restricting the number of terminals permitted to communicate with the orbiting satellite within the cell.

6. The communication control system according to claim 1, wherein the permissible load is determined based on at least one of a distance between the orbiting satellite and the cell or an elevation angle of the orbiting satellite as viewed from the location of the cell.

7. The communication control system according to claim 1, wherein the communication restriction process includes repeatedly executing a determination as to whether to restrict the communication of the some or all of the one or more terminals which are communicable with the orbiting satellite within the cell based on a most recent monitoring result of the load of the cell.

8. The communication control system according to claim 1,
wherein the cell is formed by at least one orbiting satellite which is within a predetermined range among a plurality of orbiting satellites, and
wherein the communication restriction process includes transmitting a restriction instruction to the some or all of the one or more terminals for which the communication is restricted via the at least one orbiting satellite forming the cell among the plurality of orbiting satellites.

9. The communication control system according to claim 1, wherein the permissible load varies periodically over time.

10. The communication control system according to claim 1, wherein the communication control system further executes a resource allocation process of allocating, to a terminal which is permitted to communicate with the orbiting satellite, an amount of resources corresponding to a communication usage of the terminal.

11. The communication control system according to claim 1, wherein the communication restriction process includes restricting, in a situation in which communication by terminals present in the cell is restricted, the communication of the some or all of the one or more terminals which are communicable with the orbiting satellite within the cell based on the situation of restriction of the communication.

12. The communication control system according to claim 1, wherein the location of the cell is fixed regardless of the location of the orbiting satellite.

13. The communication control system according to claim 1, wherein the orbiting satellite is a low-earth orbiting satellite.

14. The communication control system according to claim 1, wherein the permissible load indicates at least one of a permissible traffic amount, a permissible number of in-cell terminals, or a permissible number of active terminals.

15. The communication control system according to claim 1, wherein the load of the cell indicates at least one of a traffic amount of the cell, the number of in-cell terminals of the cell, or the number of active terminals of the cell.

16. A communication control method, comprising:
monitoring a load of a cell formed by an orbiting satellite; and
restricting communication of some or all of one or more terminals which are communicable with the orbiting satellite within the cell, based on a permissible load at a given time point determined from a location of the orbiting satellite at the given time point and a location of the cell, and on an actual result value or a predicted value of the load of the cell at the given time point.
